(19) United States
(12) Patent Application Publication
(10) Pub. No.: US 2026/0225676 A1
(43) Pub. Date: Aug. 6, 2026

(54) SEAT POST ASSEMBLY

(71) Applicant: Bastille Cycles, Paris (FR)

(72) Inventor: Gilles Henry, Paris (FR)

(73) Assignee: Bastille Cycles, Paris (FR)

(21) Appl. No.: 18/879,623

(22) PCT Filed: Jun. 29, 2023
(86) PCT No.: PCT/EP2023/067893

§ 371 Date: Oct. 6, 2025

(30) Foreign Application Priority Data
Jun. 29, 2022 (FR) FR2206572

(51) Int. Cl. B62J 1/08

(52) U.S. Cl. CPC B62J 1/08; B62J 2001/085

(57) ABSTRACT

Seat post assembly comprising: a seat post (1) mounted so as to be able to slide in a seat tube (20); a link rod (17) extending inside the seat post (1); a base (6) fastened to the upper end of the seat post (1); a seat support (10) mounted on the base (6) and to which a saddle (18) may be fastened; and a blocking system that is able to be actuated between an unlocked position in which the blocking system does not prevent the sliding of the seat post (1), and a locked position in which the blocking system blocks the seat post (1) in position inside the seat tube (20). The blocking system is actuated by the movement of the link rod (17), and the seat support (10) is mounted so as to be able to rotate on the base (6) and connected to the link rod (17) such that the rotation of the seat support (10) drives the link rod (17) in movement.

### TECHNICAL FIELD

The invention relates to a seat post assembly. This assembly may be mounted, in particular, on a bicycle.

More specifically, the invention relates to a seat post assembly equipped with a blocking system that makes it possible to change and fix the height of the seat post.

### BACKGROUND

Numerous blocking systems for bicycle seat posts exist.

A blocking system used for bicycle seat posts (but also for handlebar posts) comprises a link rod extending inside the seat post and a wedge connected to the link rod. The link rod is able to move between a low position in which the wedge does not oppose the sliding of the seat post inside the seat tube that surrounds it, and a high position in which the wedge opposes the sliding and blocks the seat post in position. An exemplary system of this type is described in the patent document FR 2432424. Such a blocking system is appreciated for its robustness and its reliability. However, the manipulations required to block and unblock this system are not easy and often require tools. This drawback is acceptable when the height of the seat post is adjusted to the size of its only user once and for all.

By contrast, this drawback quickly becomes bothersome when the height of the seat post has to be adjusted frequently, as is the case for a bicycle shared between a plurality of users. This drawback also becomes bothersome when the seat post has to be frequently withdrawn as far as possible into the seat tube so as to reduce the bulk of the bicycle, as is the case for most folding bicycles.

There is therefore a need for a seat post blocking system that is easy to manipulate and does not require any tools.

### General Presentation

A seat post assembly according to the invention comprises:
a seat post adapted to be slidably mounted in a seat tube,
a link rod extending inside the seat post, the link rod being movable with respect to the seat post between a low position and a high position,
a base fastened to the upper end of the seat post,
a seat support to which a saddle may be fastened, the seat support being mounted on the base, and
a blocking system that is able to be actuated between an unlocked position in which the blocking system does not prevent the sliding of the seat post inside the seat tube, and a locked position in which the blocking system prevents the sliding and blocks the seat post in position inside the seat tube.

The blocking system is actuated by the movement of the link rod between its high and low positions.

The seat support is rotatably mounted on the base, about a first axis, and connected to the link rod such that the rotation of the seat support about the first axis drives the link rod between its high and low positions.

Thus, when a saddle is fastened to the seat support, it is sufficient for the user to pivot the saddle, and with it the seat support, about the first axis to lock and unlock the blocking system. The manipulation required is therefore particularly easy.

In certain embodiments, the seat support is connected to the link rod by a lever pivotably mounted on the base about a second axis, a first arm of the lever extending on one side of the second axis and being connected to the link rod so as to drive the link rod between its high and low positions, and a second arm of the lever extending on the other side of the second axis and being driven in rotation about the second axis by the rotation of the seat support about the first axis. This lever connection has the advantage of being simple and robust. In addition, by adjusting the length of the arms of the lever, the lever makes it possible to amplify the force exerted by the user. Thus, a moderate force is sufficient to drive the link rod between its high and low positions and therefore to lock and unlock the blocking system.

The invention also relates to a vehicle comprising the seat post assembly defined above, a frame with a seat tube in which the seat post is slidably mounted, and a saddle fastened to the seat support. This vehicle may be a bicycle or any other vehicle equipped with a saddle.

The abovementioned features and advantages, along with others, will become apparent upon reading the following detailed description. This detailed description makes reference to the appended drawings.

### BRIEF DESCRIPTION OF THE DRAWINGS

The appended drawings are schematic and not necessarily to scale; they are intended primarily to illustrate the principles of the invention. In these drawings, elements (or parts of elements) that are identical are identified by the same reference signs from one figure (Fig.) to another.

FIG. 1 This figure depicts an example of a seat post assembly comprising a blocking system for blocking the seat post in position inside a seat tube.

FIG. 2 This figure is an exploded view of the seat post assembly in FIG. 1.

FIG. 3 This figure is a view in axial cross section of the seat post assembly in FIG. 1. The seat post is engaged in a seat tube and equipped with a saddle. The saddle is in its position of use, the upper face of the saddle being substantially horizontal.

FIG. 4 This figure is a view in cross section similar to that of FIG. 3, wherein the saddle is upright, the upper face of the saddle being close to the vertical.

FIG. 5 This figure is a view in cross section similar to that of FIG. 3, wherein the saddle is tilted towards the rear. The saddle is inverted, its upper face turned downwards.

FIG. 6 This figure is a detail view of another example of a blocking system.

FIG. 7 This figure is an exploded view of the blocking system in FIG. 6.

FIG. 8 This figure is a view in axial cross section of the blocking system in FIG. 6 in the unlocked position.

FIG. 9 This figure is a view in axial cross section of the blocking system in FIG. 6 in the locked position.

### DETAILED DESCRIPTION

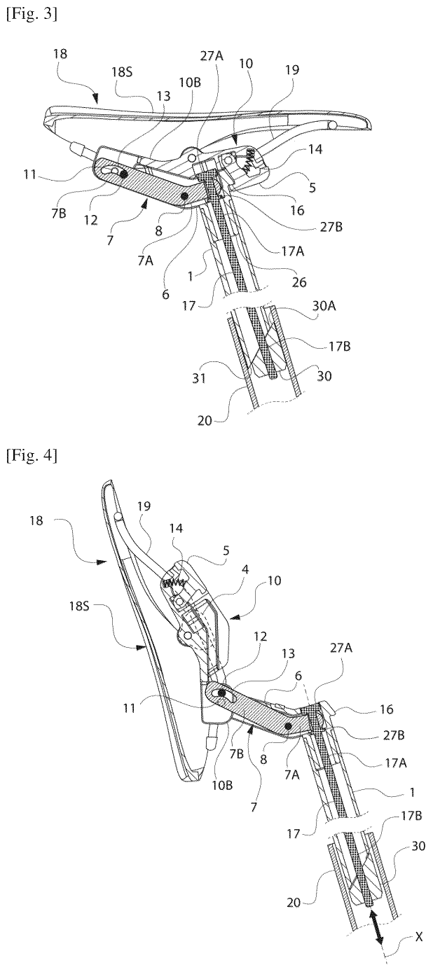

Particular embodiments of the proposed seat post assembly are described in detail below, with reference to the examples depicted in the appended drawings. These embodiments illustrate the features and advantages of the invention. It should be noted, however, that the invention is not limited to these embodiments. In certain embodiments, as in the example depicted in the figures, the seat post assembly comprises a seat post 1 designed to be mounted so as to be able to slide in a seat tube 20. The upper end 1A of the seat post 1 bears a seat support 10 to which a saddle 18 is fastened. FIG. 3 depicts the saddle 18 in its position of use. In this position, the user sits on the upper face 18S of the saddle 18.

In the present application, the horizontal and the vertical are defined with respect to the position of use of the saddle 18, depicted in FIG. 3. The upper face 18S of the saddle is substantially horizontal in this position of use. The top and the bottom are defined with respect to the vertical direction. The front and the rear are defined with respect to the horizontal direction and to the normal position of the user on the saddle 18, the user facing forwards.

In the example shown in the figures, the saddle 18 comprises fastening rails 19 on its lower face. These rails 19 extend in the direction of the length of the saddle 18. The rails 19 are retained in jaws 4 provided on either side of the seat support 10. These jaws 4 are clamped around the rails 19 by means of a screw 3. This fastening system complies with current standards such that the majority of commercially available saddles with rails can be fastened to the seat support 10. Of course, other fastening systems can be envisaged for fastening the saddle 18 to the seat support 10.

The seat post assembly also comprises a blocking system 2 for blocking the seat post 1 in position inside a seat tube 20 and a link rod 17 extending inside the seat post 1 and connected to the blocking system 2.

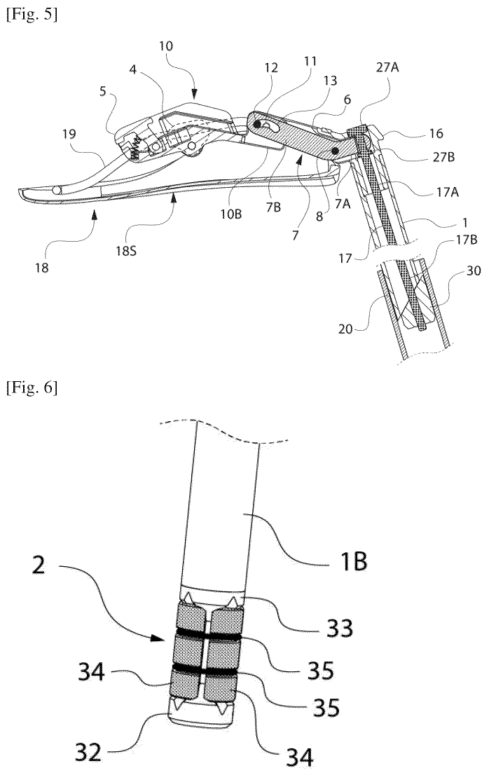

The link rod 17 is able to move with respect to the seat post 1 between a low position, illustrated in FIG. 4, and a high position illustrated in FIGS. 3 and 5. The blocking system 2 is actuated by the movement of the link rod 17 between its high and low positions. The blocking system 2 is able to be actuated between an unlocked position in which the blocking system does not prevent the sliding of the seat post 1 inside the seat tube 20, and a locked position in which the blocking system prevents the sliding and blocks the seat post 1 in position inside the seat tube 20.

In the example, when the link rod 17 is in the low position, the blocking system 2 is in the unlocked position and does not prevent the sliding of the seat post 1 inside the seat tube 20, and when the link rod 17 is in the high position, the blocking system 2 is in the locked position and prevents the sliding and blocks the seat post 1 in position inside the seat tube 20. The high and low positions of the link rod 17 therefore correspond, respectively, to the unlocked and locked positions of the blocking system 2. A reverse correspondence could however be envisaged without departing from the scope of the invention.

In certain embodiments, as in the example depicted in the figures, the link rod 17 passes through the seat post 1 and the lower end 17B of the link rod 17 extends beyond the lower end 1B of the seat post 1. The blocking system 2 is fastened to the lower end 17B of the link rod 17 such that the link rod 17 drives a part of the blocking system 2 in its movement so as to actuate the blocking system 2.

In certain embodiments, the blocking system 2 comprises a wedge 30 and the lower end 1B of the seat post 1 is beveled along an inclined plane 31 that forms a non-zero angle with a plane orthogonal to the main axis X of the seat post 1, for example an angle of between 30 and 60°. The wedge 30 is borne by the link rod 17 and has an inclined surface 30A facing the inclined plane 31. When the link rod 17 passes from its low position to its high position, the link rod 17 pulls the wedge 30 upwards such that the inclined surface 30A is pressed and slides against the inclined plane 31, thus causing the offsetting of the wedge 30 with respect to the main axis X of the seat post 1. The wedge 30 then comes to bear against an inner wall of the seat tube 20 and pushes the seat post 1 against the opposite inner wall, as illustrated in FIGS. 3 and 5. The friction generated prevents the seat post 1 from sliding inside the seat tube 20 and thus blocks the seat post 1 in position.

In the present application, wedge or chock denotes a mobile mechanical member capable of exerting a blocking force in an assembly of components in order to block the relative movement between these components. In this case, the wedge 30 makes it possible to block the relative movement between the seat post 1 and the seat tube 20.

Another example of a blocking system 2 is described below, with reference to FIGS. 6 to 9. These examples of blocking systems 2 have the advantage of being robust and reliable. In particular, they are more reliable than systems that use a collar to clamp the seat tube and press it against the seat post.

The seat post assembly also comprises a base 6 fastened to the upper end 1A of the seat post 1. In the example, the base 6 comprises a sleeve 26 engaged and fastened in the upper end 1A of the seat post 1. The seat support 10 is mounted so as to be able to rotate on the base 6, about a first axis 11, and connected to the link rod 17 such that the rotation of the seat support 10 about the first axis 11 drives the link rod 17 between its high and low positions.

In certain embodiments, as in the example shown in the figures, the upper part of the base 6 extends towards the rear from the seat post 1, i.e., from the sleeve 26. The upper part of the base 6 has a front wall forming or bearing a hook 16 and two lateral walls ending, towards the rear, in two arms 6A. The upper part of the base 6 is hollow and devoid of lower wall and rear wall.

The rear part 10B of the seat support 10 is mounted so as to be able to rotate between the two arms 6A, about the first axis 11. In this way, the seat support 10 can describe a relative rotational movement with respect to the base 6.

In this example, the first axis 11 is a rotation axis embodied by two screws 11A disposed in the same direction, facing one another. These screws 11A are screwed into the arms 6A from the outside. They pass through the thickness of the arms 6A and are housed in a cylindrical hole passing through the rear part 10B of the seat support 10. The screws together form a shaft (in two parts) on which the seat support 10 bears so as to pivot.

Other configurations can of course be envisaged for realising the articulation between the seat support 10 and the base 6. For example, two spindles may extend on either side of the rear part 10B of the seat support 10 and be supported, respectively, by two bearings formed in the arms 6A. According to another example, the first rotation axis 11 may be a shaft (in a single piece) passing through the seat support 10 and the arms 6A.

According to another example, the first rotation axis 11 is not embodied by any component and is merely an imaginary straight line around which the rotational movement takes place. In the latter case, the articulation between the seat support 10 and the base 6 is realised, for example, by fitting a circular groove in a circular rib.

In certain embodiments, the seat support 10 is connected to the link rod 17 by means of a lever 7 mounted so as to be able to pivot on the base 6 about a second axis 8. The lever 7 comprises two arms extending on either side of the second axis 8. The first arm 7A of the lever extends on one side of the second axis 8 and is connected to the link rod 17 so as to drive the link rod 17 between its high and low positions. The second arm 7B of the lever extends on the other side of the second axis 8 and is driven in rotation about the second axis 8 by the rotation of the seat support 10 about the first axis 11.

In the example, the second axis 8 is a rotation axis embodied by a shaft passing through the lever 7 and supported by two bearings formed in the lateral walls of the base 6. Other configurations can however be envisaged for the articulation of the lever 7. For example, the second rotation axis 8 may be formed by two spindles extending on either side of the lever 7. The lever 7 may be pierced with a piercing 9 through which the second axis 8 can pass.

In certain embodiments, the first arm 7A of the lever is longer than the second arm 7B. Further, the lever 7 may have a bent shape, the second axis 8 being situated at the bend of the lever 7.

In certain embodiments, the lever 7 is housed inside the base 6, between the lateral walls (i.e., between the arms 6A) of the base 6. Likewise, the upper end 17A is housed inside the base 6, the link rod 17 passing through the sleeve 26. The mechanism of the blocking system is thus protected from external impacts. It is also out of reach of the user, and this makes it possible to avoid the risk of trapping.

In certain embodiments, the upper end 17A of the link rod 17 passes through the first arm 7A of the lever 7 and has, on either side of the first arm 7A, an upper stop 27A and a lower stop 27B, the first arm 7A being against the upper stop 27A when the link rod 17 is in the high position and against the lower stop 27B when the link rod 17 is in the low position. In other words, when the first arm 7A is lifted, it comes to abut against the upper stop 27A and pulls the post 27 upwards.

Conversely, when the first arm 7A is lowered, it comes to abut against the lower stop 27B and pushes the post 27 downwards. In the example shown in the figures, the stops 27A, 27B have the shape of collars and the end of the first arm 7A forms a fork. This fork is engaged around the post 27, between the stops 27A, 27B.

In certain embodiments, as in the example depicted in the figures, the seat support 10 is able to move in rotation about the first axis 11 between three positions, namely:
a bearing position, corresponding to the position of use of the saddle 18, in which the seat support 10 is the right way up, bearing on the base 6;
an inverted position in which the seat support 10 is tilted towards the rear of the base 6; and
an intermediate position between the bearing position and the inverted position.

These three positions are depicted, respectively, in FIGS. 3, 5 and 4.

In FIG. 3, the seat support 10 is in the bearing position and the saddle 18 is in its position of use. The upper face 18S of the saddle is substantially horizontal so as to allow a user to sit thereon.

In FIG. 4, the seat support 10 is in the intermediate position and the saddle 18 is upright, the upper face 18S of the saddle being close to the vertical.

In FIG. 5, the seat support 10 is in the inverted position. The support 10 and the saddle 18 are tilted towards the rear. The saddle is inverted, its upper face 18S being turned downwards.

The link rod 17 is in the high position when the seat support 10 is in the bearing position; in the low position when the seat support 10 is in the intermediate position; and once again in the high position when the seat support 10 is in the inverted position.

In certain embodiments, the seat support 10 (in this case, the rear part 10B of the seat support 10) bears a pin 12. Further, an oblong opening 13 is provided in the second arm 7B of the lever 7. The oblong opening 13 and the seat support 10 are configured so that the pin 12 moves in and along the oblong opening 13 during the rotation of the seat support 10 about the first axis 11. The movement of the pin 12 in the oblong opening 13 then makes the lever 7 pivot about the second axis 8, as depicted in FIGS. 3 to 5.

The pin 12 describes a circular path during the rotation of the seat support 10 about the first axis 11. In the example, the oblong opening 13 is curved in the same direction as the circular path, the curvature of the oblong opening 13 being less than the curvature of the circular path of the pin 12.

The operation of the blocking system is described below, with reference to FIGS. 3 to 5.

When the seat support 10 is in the bearing position, the pin 12 is situated at a first end of the oblong opening 13, as depicted in FIG. 3. The second arm 7B of the lever 7 is then in the low position and, conversely, the first arm 7A is in the high position. The first arm 7A is in abutment against the upper stop 27A of the link rod 17 and pulls the link rod 17 upwards. The link rod 17 is then in the high position and the blocking system 2 is locked: the seat post 1 is blocked in position inside the seat tube 20.

In certain embodiments, in order to hold the seat support 10 in the bearing position, the seat support 10 may be equipped with a coupling system making it possible to couple the seat support to the base 6. For example, the seat support 10 may be equipped with a hook 5 coming to be engaged with another hook 16 borne by the base 6. The hook 5 may be held in the engaged position by a compression spring 14. In order to disengage the hook 5 from the other hook 16, the user exerts on the hook 5 a force opposite to that of the spring 14. In order to make the manipulation easier, the hook 5 may be equipped with a tab, or tongue, on which the user can press to disengage, or unhook, the hook 5. The hook 5 may be mounted so as to be able to rotate on the seat support 10 about an axis 15. Of course, other coupling systems can be envisaged for coupling the seat support 10 to the base 6. For example, the other hook 16 may be replaced by an opening provided in the base 6 and in which the hook 5 comes to be hooked.

In order to unlock the blocking system 2, the user unhooks the hook 5 and lifts the saddle 18 and, with it, the seat support 10 as far as the intermediate position depicted in FIG. 4. The pin 12 then moves towards the middle of the oblong opening 13, and this lifts the second arm 7B of the lever 7. The second arm 7B of the lever 7 is then in the high position and, conversely, the first arm 7A is in the low position. The first arm 7A comes to abut against the lower stop 17B of the link rod and pushes the link rod 17 downwards. The link rod 17 is then in the low position and the blocking system 2 is unlocked: the seat post 1 is free to slide inside the seat tube 20. This freedom of movement is schematically shown by a double arrow in FIGS. 4 and 8.

In the case of a conventional (i.e. non-folding) bicycle and, in particular, a bicycle shared between a plurality of users, once the blocking system 2 has been unlocked, the height of the saddle 18 can be adjusted to the size of its new user. Once the height of the saddle 18 has been adjusted, the saddle 18 may be folded over towards its position of use in FIG. 3 so as to lock the blocking system 2 and block the saddle 18 in position.

In the case of a folding bicycle, once the blocking system 2 has been unlocked, the seat post 1 may be withdrawn (i.e. lowered) as far as possible into the seat tube 20 so as to limit the size of the bicycle in the folded position. Once the seat post 1 has been withdrawn, the saddle 18 may be folded over forwards, towards its position of use in FIG. 3, so as to lock the blocking system 2 and block the saddle 18 in position.

As a variant, the saddle 18 and, with it, the seat support 10, may be tilted towards the rear, towards the inverted position shown in FIG. 5. The pin 12 then moves towards the second end of the oblong opening 13, and this lowers the second arm 7B of the lever 7. The second arm 7B of the lever 7 is then in the low position and, conversely, the first arm 7A is in the high position. The first arm 7A comes to abut against the upper stop 17A of the link rod and pulls the link rod 17 upwards. The link rod 17 is then in the high position and the blocking system 2 is locked: the seat post 1 is blocked in position inside the seat tube 20.

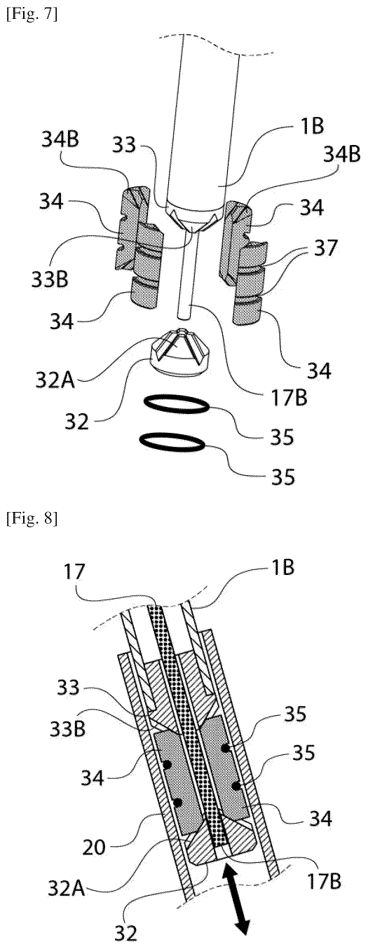

The possibility of tilting the saddle 18 towards the rear, towards the inverted position shown in FIG. 5, is optional. This possibility has an advantage for a folding bicycle, such as that described in the patent document EP 3634842 B1, in which the saddle is tilted towards the rear so as to reduce the size of the folded bicycle as much as possible. See FIG. 7B of document EP 3634842 B1. In such a case, the fact that the blocking system 2 is locked when the saddle 18 is in the inverted position (FIG. 5), allows the user to manipulate the folded bicycle by holding it by the saddle 18 if desired. This also makes it possible to transport the folded bicycle without the risk of the seat post 1 coming out of the seat tube 20. The pin 12 and the oblong opening 13 are an example of a drive system for driving the lever 7. Other drive systems can be envisaged. For example, in certain embodiments (not illustrated) the seat support 10 bears a cam that is driven in rotation about the first axis 11 by the rotation of the seat support 10 about the first axis 11, and the second arm 7B of the lever 7 is pressed against an outer profile of the cam. The second arm 7B is then used as cam follower. The rotation of the cam about the first axis 11 makes it possible to lift or lower the second arm 7B of the lever 7.

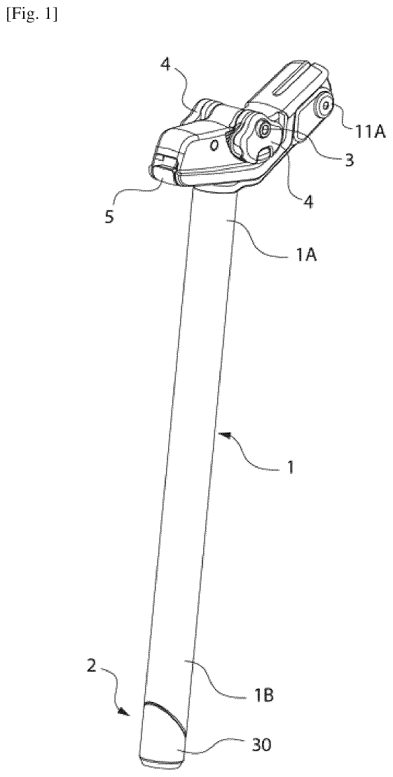

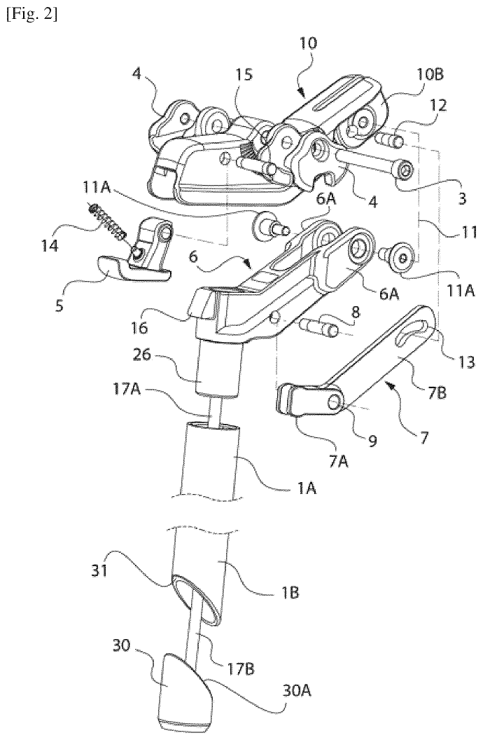

Another example of a blocking system 2 is depicted in FIGS. 6 to 9. This system may be used in place of the blocking system depicted in FIGS. 1 and 2. The blocking system 2 comprises: a lower cone 32 connected to the lower end 17B of the link rod 17; an upper cone 33 fastened to the lower end 1B of the seat post 1, the apexes of the lower and upper cones facing one another; and a plurality of wedges 34 disposed circumferentially around the link rod 17, between the cones 32, 33.

When the link rod 17 passes from its low position to its high position, the link rod 17 pulls the lower cone 32 upwards such that the lower and upper cones move closer together and clamp the wedges 34 between them, thus causing the wedges 34 to move radially away from the link rod 17. The wedges 34 then come to bear against an inner wall of the seat tube 20. The friction generated prevents the seat post 1 from sliding inside the seat tube 20 and thus blocks the seat post 1 in position.

In some embodiments, as depicted in FIGS. 6 to 9, the upper cone 33 is pierced at its centre to allow the link rod 17 to slide.

The lower cone 32 and the upper cone 33 respectively have inclined surfaces 32A and 33B of conical overall shape. The wedges 34 are beveled in their upper and lower part along inclined surfaces 34A, 34B.

The wedges 34 may be held together and around the link rod 17 by elastic rings 35 that surround them. To this end, grooves 37 may be provided on the outer face of the wedges 34 to receive the rings 35.

In the unlocked position (FIG. 8), when the link rod 17 is in the low position (corresponding to FIG. 4), the elastic rings 35 hold the wedges 34 close to the link rod 17, and the seat post 1 is free to slide inside the seat tube 20.

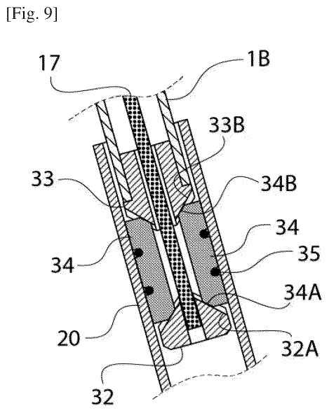

During locking (FIG. 9), when the link rod 17 passes from the low position to the high position (as illustrated in FIGS. 3 and 5), the lower cone 32 moves closer to the upper cone 33. Under the effect of the inclined surfaces 34A and 34B coming respectively to bear against the inclined surfaces 32A and 33B, the wedges 34 move radially away from the link rod 17 (i.e., in a direction perpendicular to the axis of the link rod 17) and come to press against the inner wall of the seat tube 20. The friction generated prevents the seat post 1 from sliding inside the seat tube 20 and thus blocks the seat post 1 in position.

The outer face of the wedges 34 may have, in a radial plane, a radius of curvature substantially identical to the radius of curvature of the inner wall of the seat tube 20, so as to maximise friction.

The presence of the grooves 37 on the outer face of the wedges 34 makes it possible to avoid or limit friction forces at the elastic rings 35. The wear of the elastic rings 35 is thereby decreased.

The embodiments described in the present disclosure are given by way of illustration and without limitation, and a person skilled in the art may easily, in light of this disclosure, modify these embodiments or envisage other ones while remaining within the scope of the invention.

In particular, a person skilled in the art will easily be able to envisage variants comprising only some of the features of the embodiments described above, if these features alone are sufficient to achieve one of the advantages of the invention. In addition, the various features of these embodiments may be used alone or be combined with one another. When they are combined, these features may be combined as described above or otherwise, the invention not being limited to the specific combinations described in the present disclosure. In particular, unless otherwise specified, a feature described in relation to one embodiment may be applied in an analogous manner to another embodiment.

1. A seat post assembly comprising:
a seat post adapted to be slidably mounted in a seat tube,
a link rod extending inside the seat post, the link rod being movable with respect to the seat post between a low position and a high position,
a base fastened to the upper end of the seat post,
a seat support to which a saddle may be fastened, the seat support being mounted on the base, and
a blocking system that is able to be actuated between an unlocked position in which the blocking system does not prevent the sliding of the seat post inside the seat tube, and a locked position in which the blocking system prevents the sliding and blocks the seat post in position inside the seat tube,
wherein the blocking system is actuated by the movement of the link rod between its high and low positions, and
wherein the seat support is rotatably mounted on the base, about a first axis, and connected to the link rod such that the rotation of the seat support about the first axis drives the link rod between its high and low positions.

2. The seat post assembly as claimed in claim 1, wherein the seat support is connected to the link rod by a lever pivotably mounted on the base about a second axis, a first arm of the lever extending on one side of the second axis and being connected to the link rod so as to drive the link rod between its high and low positions, and a second arm of the lever extending on the other side of the second axis and being driven in rotation about the second axis by the rotation of the seat support about the first axis.

3. The seat post assembly as claimed in claim 2, wherein the seat support bears a pin and wherein an oblong opening is provided in the second arm of the lever, the oblong opening and the seat support being configured so that the pin moves in and along the oblong opening during the rotation of the seat support about the first axis, the movement of the pin in the oblong opening making the lever pivot about the second axis.

4. The seat post assembly as claimed in claim 3, wherein the pin describes a circular path during the rotation of the seat support about the first axis, and wherein the oblong opening is curved in the same direction as the circular path, the curvature of the oblong opening being less than the curvature of the circular path of the pin.

5. The seat post assembly as claimed in claim 2, wherein the seat support bears a cam that is driven in rotation about the first axis by the rotation of the seat support about the first axis, and wherein the second arm of the lever is pressed against an outer profile of the cam.

6. The seat post assembly as claimed in claim 2, wherein the upper end of the link rod passes through the first arm of the lever and has, on either side of the first arm, an upper stop and a lower stop, the first arm being against the upper stop when the link rod is in the high position and against the lower stop when the link rod is in the low position.

7. The seat post assembly as claimed in claim 1, wherein the blocking system is in the locked position when the link rod is in the high position, and is in the unlocked position when the link rod is in the low position.

8. The seat post assembly as claimed in claim 7, wherein the seat support is able to move in rotation about the first axis between three positions, namely:
a bearing position, corresponding to the position of use of the saddle, in which the seat support is the right way up, bearing on the base;
an inverted position in which the seat support is tilted towards the rear of the base; and
an intermediate position between the bearing position and the inverted position, and
wherein the link rod is:
in the high position when the seat support is in the bearing position;
in the low position when the seat support is in the intermediate position; and
once again in the high position when the seat support is in the inverted position.

9. The seat post assembly as claimed in claim 1, wherein the blocking system comprises:
a lower cone connected to the lower end of the link rod;
an upper cone fastened to the lower end of the seat post, the apexes of the lower and upper cones facing one another; and
a plurality of wedges disposed circumferentially around the link rod, between the lower and upper cones,
wherein, when the link rod passes from its low position to its high position, the link rod pulls the lower cone upwards such that the lower and upper cones move closer together and clamp the wedges between them, thus causing the wedges to move radially away from the link rod.

10. The seat post assembly as claimed in claim 1, wherein the lower end of the seat post is beveled along an inclined plane that forms a non-zero angle with a plane orthogonal to the main axis of the seat post, wherein the blocking system comprises a wedge having an inclined surface facing the inclined plane, and wherein, when the link rod passes from its low position to its high position, the link rod pulls the wedge upwards such that the inclined surface is pressed and slides against the inclined plane, thus causing the offsetting of the wedge with respect to the main axis of the seat post.

11. A vehicle comprising a seat post assembly as claimed in claim 1, a frame with a seat tube in which the seat post is mounted so as to be able to slide, and a saddle fastened to the seat support.
